(19) United States
(12) Patent Application Publication
(10) Pub. No.: US 2010/0088821 A1
(43) Pub. Date: Apr. 15, 2010

(54) Nursing bed of thermal insulation type

(76) Inventor: Xiading Wang, FUJIIAN (CN)

Correspondence Address: Allan chan &associates, 225 broadway suite 700, New york, NY, 10007, US

(21) Appl. No.: 12/311,083

(22) PCT Filed: Sep. 18, 2007
(86) PCT No.: PCT/CN2007/002741

§ 371 Date: Mar. 18, 2009

(30) Foreign Application Priority Data
Sep. 19, 2006 (CN) 200620099098.1

(51) Int. Cl. A61G 7/00; A61G 7/02; A47C 21/04

(52) U.S. Cl. 5/604; 5/600

(57) ABSTRACT

The invention relates to a thermal insulation nursing bed which comprises a bed frame and supporting legs. The upper edge of the bed frame is provided with a meshed sheet body while the bottom edge of the bed frame is provided with a fixed thermal insulation bottom hood which facilitates thermal insulation for the bottom of the meshed sheet body. When the upper part of the body of the patient is covered with a quilt and other beddings, the patient lying in the bed will be kept warm. The meshed sheet body is also characterized in favorable ventilation and easy to clean. The invention, rational in design and simple in structure, effectively facilitates the solution of problems in the traditional nursing bed which is poor in ventilation. In addition, the invention also facilitates the cleaning of the nursing bed as the sewage can be directly collected and discharged through the outlet at the bottom. Furthermore, if the air-conditioner is arranged in the space formed by the thermal insulation layer, the temperature can be easily under control on the one hand and internal air dehumidification will be available on the other. Therefore, the back of the patient will be kept dry and cool so that the patient will not be susceptible to bedsore and other skin diseases. The difficulty in nursing work can also be reduced.

### FIELD OF TECHNOLOGY

The invention relates to a nursing bed with air ventilation and thermal insulation functions for the use of bed-ridden paralyzed patients.

### BACKGROUND OF TECHNOLOGY

The existing nursing beds are limited in function, consisting of bedstead and mattress placed on the bedstead. The mattress is generally and simply made of thermal insulation materials. In summer, a piece of summer sleeping mat can be laid on the mattress with a view to cooling. But for a patient lying in the bed for a long time, owing to the poor ventilation at the side of the body lying on the mat, the patient often suffers from bedsore or frostbite; In addition, since patients can not take care of themselves, they often excrete the feces and urine in bed, which are difficult to be thoroughly washed and leave smell and further affect the living environment of the wards. The nursing bed in my original application put forward the use of meshed mattress facilitating solving problems in air ventilation and cleaning. However, there is still such defect as poor thermal insulation. To resolve the problem in such mattress for use in autumn and winter is therefore the subject of the invention.

### CONTENTS OF THE INVENTION

The purpose of the invention is to design a nursing bed which is favorable in air ventilation, easy to clean, and features by thermal insulation.

The technical proposal of the invention is realized as follows: a thermal insulation nursing bed comprises a bed frame and supporting legs; the upper edge of the bed frame is provided with a tightened meshed sheet body while the bottom edge of the bed frame is provided with a thermal insulation bottom hood for thermal insulation of the bottom of the meshed sheet body. When the upper part of the body of the patient is covered with a quilt and other beddings, the patient lying in bed will be kept warm. The meshed sheet body is characterized by being favorable in ventilation and easy to clean.

The bottom hood is arranged at the place where the hip of the patient lays, in the shape of a concave funnel; an outlet is arranged at the lowest place of the funnel, which facilitates the discharge of flushing water.

The thermal insulation bottom hood at least comprises a strengthening layer, a thermal insulation material layer, and a waterproofing layer at the inner surface. The strengthening layer ensures that the thermal insulation material layer can be firmly attached and not be easily damaged in the washing operations. The waterproofing layer can effectively prevent sewage water from polluting or eroding the strengthening layer and the thermal insulation material layer.

The invention, rational in design and simple in structure, effectively solves problems of the traditional nursing bed on which the patient tends to suffer from bedsore or frostbite due to poor ventilation and facilitates cleaning the bed since sewage water can be directly discharged out through a discharge outlet at the bottom. If an air-conditioner is arranged in the space formed by the thermal insulation layer, not only the easy control of temperature, but also the dehumidification can be realized; thus the back of the patient can be kept dry and cool, reducing the chance of suffering from skin diseases and further facilitating the nursing work.

### STATEMENT OF THE APPENDED DRAWINGS

Further explanations will be given below by way of specific legends illustrated:

FIG. 1—Exploded View of Thermal Insulation Nursing Bed

FIG. 2—Three-dimensional Figure of Thermal Insulation Nursing Bed

FIG. 3—Internal Structure of Thermal Insulation Nursing Bed

FIG. 4—Schematic View of Cross-section of Thermal Insulation Nursing Bed

FIG. 5—Schematic View of the End Part of Thermal Insulation Nursing Bed

| | | |
|---|---|---|
| 1 - bed frame | 2 - supporting leg | 3 - meshed sheet body |
| 4 - bottom hood | 5 - air-conditioner | 11 - Track |
| 12 - manipulator platform | | 13 - motor |
| 40 - discharge outlet | | 41 - funnel-shaped |
| 42 - oil-feeding layer | | structure |
| 44 - waterproofing layer | | 43 - thermal insulation |
| | | material layer |
| | | 45 - through-hole |

### Specific Method of Use:

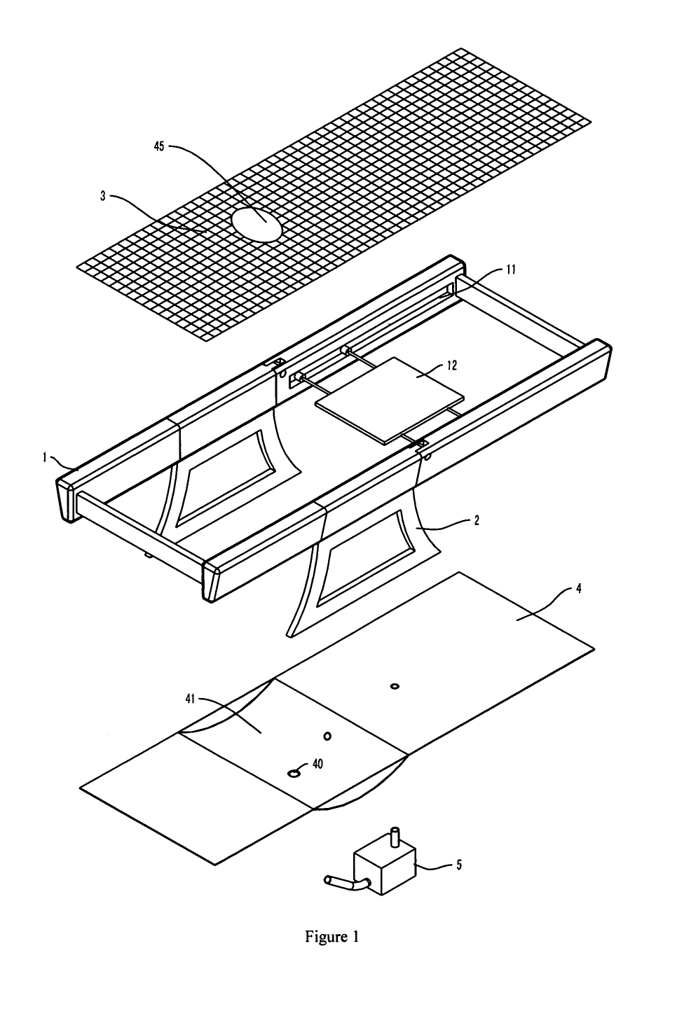

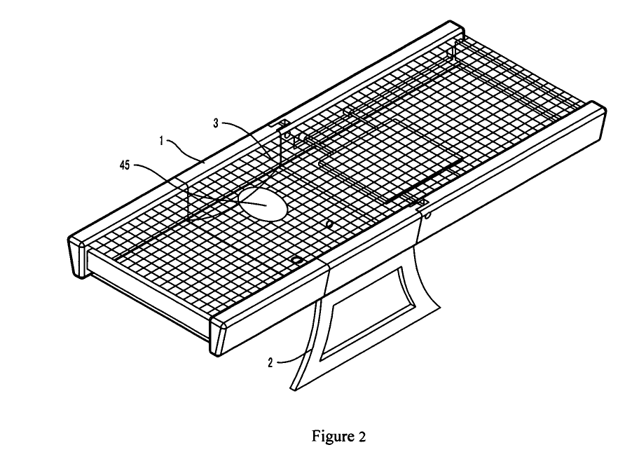

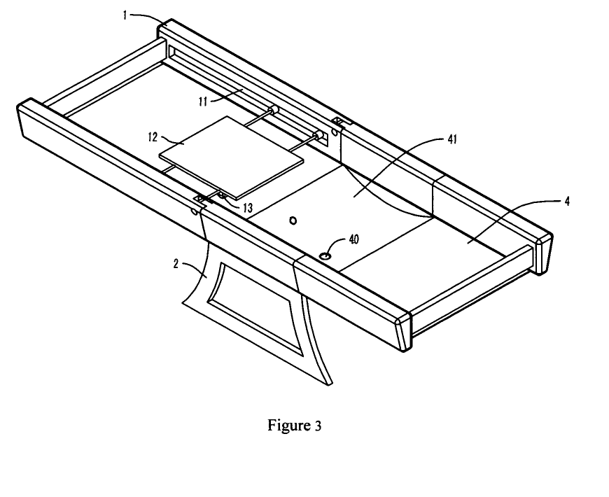

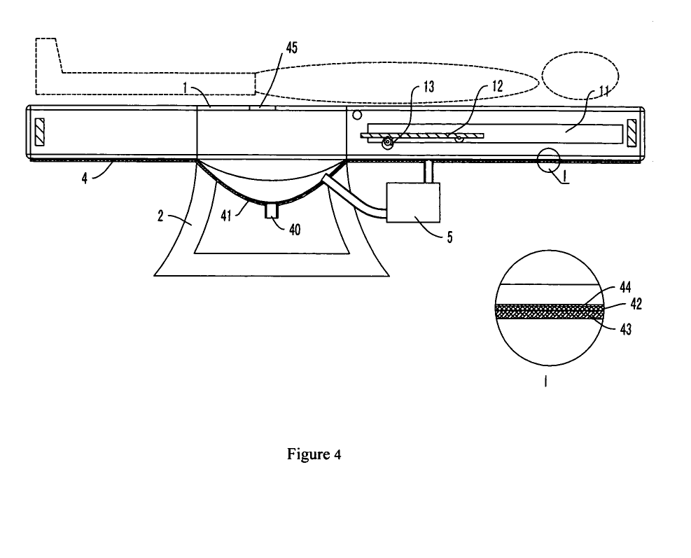

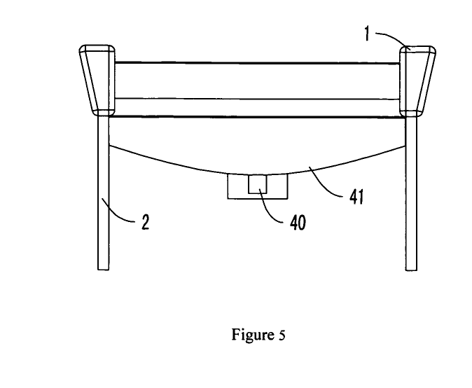

With reference to FIG. 1, FIG. 2, FIG. 3, FIG. 4 and FIG. 5, a thermal insulation nursing bed comprises a bed frame 1 and supporting legs 2; the upper edge of the bed frame 1 is provided with a tightened meshed sheet body 3 while the bottom edge of the bed frame 1 is provided with a fixed bottom hood 4. Between the bottom hood 4 and the meshed sheet body 3, a space is provided. The space facilitates air ventilation and is also provided other therapeutic equipment. The bottom hood 4 is arranged in a funnel-shaped structure 41 at the place where the hip of the patient lays. A discharge outlet 40 is arranged at the lowest part of the funnel. Sewage water from the meshed sheet body can be collected and discharged out of the discharge outlet.

In addition, in the funnel-shaped structure 41, a spray head is provided. Therefore, spraying and cleaning upwards from the bottom of the meshed sheet body 3 is available; thus the cleaning can be performed from the upper side and the lower side and all corners can be cleaned.

With reference to FIG. 4, the thermal insulation bottom hood 4 at least comprises a strengthening layer 42, a thermal insulation material layer 43 and a waterproofing layer 44 at the inner surface. The strengthening layer 42 is made of stainless steel sheet metal, plastic or metal mesh materials which are corrosion-resistant. At the external surface, the thermal insulation material layer is attached and at the internal surface, waterproofing layer 44 is provided, thus effectively preventing sewage water from polluting the strengthening layer 42 and the thermal insulation material layer 43. The waterproofing layer, as the removable structure, is attached to the stainless steel plate and other strengthening layers, which provides convenience for replacement at any time.

With reference to FIG. 1, FIG. 3 and FIG. 4, both sides of the bed frame 1 are provided with corresponding tracks 11. Between the tracks 11, a manipulator platform 12 is provided. In order to facilitate convenient operation, the manipulator platform 12 is driven by a built-in motor 13. The motor 13 drives the manipulator platform 12 up and down. The manipulator platform 12 may be provided with a variety of therapeutic equipment such as massage therapy equipment, infra-red apparatus etc which can be used to nurse the back of the patient. The space formed by the bed sheet meshed sheet body 3 and the thermal insulation bottom hood 4 is communicated with the air-conditioner 5. Therefore, the ambient temperature and humidity can be conditioned so as to maintain the most appropriate dryness and temperature for the human body and to facilitate the patient's health.

Furthermore, the meshed sheet body 3 can be of stamping molding, round meshes, rectangular meshes, hexagonal or octagonal meshes. Mesh diameter or the largest diagonal shall be less than 30 mm.

The meshed sheet body 3 can be made from woven fibers, or be woven into round meshes or a variety of geometric shapes. The diameter of the mesh or the largest diameter or diagonal line shall be less than 30 times of the diameter of the fibers.

The meshed sheet body 3 is made of transparent or translucent materials in order to facilitate observation of the inner space of the thermal insulation bottom hood and penetration of infrared and ultraviolet. The more flexible is the material, the better.

In order to facilitate the bed-ridden patient in feces and urine excretion, a through-hole 45 facilitating feces and urine excretion is designed at the meshed sheet body at the place where hip of the patient lays; thus the patient can directly defecate through the through-hole, thus facilitating nursing work on the one hand and avoiding smearing the meshed sheet body and reducing the work for cleaning the meshed sheet body on the other.

1. A thermal insulation nursing bed, comprising a bed frame and supporting legs, is characterized in that the upper edge of the bed frame is provided with a meshed sheet body while the bottom edge of the bed frame is provided with a fixed thermal insulation bottom hood; The thermal insulation bottom hood is designed at the place where the hip of the patient lays and is of funnel-shaped concave structure. A discharge outlet is arranged at the lowest place of the funnel.

2. According to the patent claim 1, the thermal insulation nursing bed is characterized in that the space within the funnel-shaped structure is provided with a spray head.

3. According to the patent claim 1 or 2, the thermal insulation nursing bed is characterized in that the thermal insulation bottom hood at least comprises a strengthening layer, a thermal insulation material layer, and a waterproofing layer at the inner surface.

4. According to patent the claim 3, the thermal insulation nursing bed is characterized in that the waterproofing layer is of the detachable structure and attached to the surface of the strengthening layer.

5. According to the patent claim 1, the thermal insulation nursing bed is characterized in that the inner sides of the bed frame are provided with corresponding tracks and between the tracks, a manipulator platform is provided. The manipulator platform is driven by a built-in motor.

6. According to the patent claim 1 or 2, the thermal insulation nursing bed is characterized in that the space formed by the meshed sheet body of the bed frame and the thermal insulation bottom hood is connected with an air-conditioner.

7. According to the patent claim 1, the thermal insulation nursing bed is characterized in that the diameter of meshes of the meshed sheet body or the largest diagonal is less than 30 mm.

8. According to the patent claim 1, the thermal insulation nursing bed is characterized in that the meshed sheet body is made of woven fibers which are of transparent or translucent materials. The diameter of the mesh or the largest diagonal shall be less than 30 times of the diameter of the fibers.

9. According to the patent claim 1, 2 or 3, the thermal insulation nursing bed is characterized in that the meshed sheet body is designed at the place where the hip of the patient lays to facilitate defecation through the through-hole.
